(19) United States
(12) Patent Application Publication
(10) Pub. No.: US 2012/0105595 A1
(43) Pub. Date: May 3, 2012

(54) METHOD FOR GENERATING THREE DIMENSIONAL IMAGE AND THREE DIMENSIONAL IMAGING SYSTEM

(75) Inventor: Yun-Chin Li, New Taipei City (TW)

(73) Assignee: ALTEK CORPORATION, Hsinchu City (TW)

(21) Appl. No.: 13/162,553

(22) Filed: Jun. 16, 2011

(30) Foreign Application Priority Data
Oct. 29, 2010 (TW) 99137273

(51) Int. Cl. H04N 13/02

(52) U.S. Cl. 348/49; 348/E13.074

(57) ABSTRACT

A method for generating a three dimensional image and a three dimensional imaging system are provided. The three-dimensional imaging system includes a left lens and a right lens. First, the left lens and the right lens are used to capture a left-eye image and a right-eye image. Next, the left-eye image and the right-eye image are analyzed, so as to find a left-eye overlapped image and a right-eye overlapped image. Then, color parameters of the left-eye overlapped image and the right-eye overlapped image are respectively calculated and used to adjust the color parameters of the whole left-eye image and the whole right-eye image, such that the color parameter of the left-eye overlapped image matches that of the right-eye overlapped image. Finally, the adjusted left-eye image and right-eye image are output as a three dimensional image.

### CROSS-REFERENCE TO RELATED APPLICATION

This application claims the priority benefit of Taiwan application serial no. 99137273, filed on Oct. 29, 2010. The entirety of the above-mentioned patent application is hereby incorporated by reference herein and made a part of this specification.

### BACKGROUND OF THE INVENTION

1. Field of the Invention

The present invention generally relates to a method for generating an image and an imaging system, in particular, to a method for generating a three dimensional (3D) image and a three dimensional imaging system.

2. Description of Related Art

A stereo camera consists of two lenses having the same specifications, and a distance between the two lenses is about 7.7 cm, thus simulating an actual distance between human eyes. Parameters of the two lenses, such as focal lengths, apertures, and shutters are controlled by a processor of the stereo camera. By triggering through a shutter release, images of the same area but of different perspectives are captured, and the images are for simulating a human left-eye image and a human right-eye image.

The left-eye image and the right-eye image captured by the 3stereo D camera are displayed by a display device alternately at a frequency exceeding persistence of vision of the human eyes, and meanwhile with the switching of liquid crystal shutter glasses worn on the human head, a human being can view the corresponding left-eye image and the right-eye image with the left and right eyes. After being conducted to the cerebral cortex, the left-eye image and the right-eye image are fused into a single image by the cortical centre. Since the left-eye image and the right-eye image captured by the stereo camera may be slightly different in angles, a certain parallax exists between two object images formed on the retinas, and the object images of different perspectives in the two eyes can be fused by the cortical centre to make a human being have a three dimensional impression.

Despite that the left lens and the right lens of the stereo camera capture images of the same area by using the same parameters, since the two lenses or optical sensors in the lenses are more or less different, even if the control parameters and the capturing methods are the same, differences still exist in brightness or color of the presentation of the images captured by the stereo camera, and the differences make the images viewed by a viewer with the two eyes match inadequately, thus affecting an imaging effect of the three dimensional image.

### SUMMARY OF THE INVENTION

Accordingly, the present invention is directed to a method for generating a three dimensional image, such that the brightness and chrominance of the left-eye image match those of the right-eye image.

The present invention provides a method for generating a three dimensional image, which is applicable to a three dimensional imaging system including a left lens and a right lens. In the method, the left lens and the right lens are used to capture a left-eye image and a right-eye image. Next, the left-eye image and the right-eye image are analyzed, so as to find a left-eye overlapped image in the left-eye image and a right-eye overlapped image in the right-eye image. Then, color parameters of the left-eye overlapped image and the right-eye overlapped image are respectively calculated and used to adjust the color parameters of the whole left-eye image and the whole right-eye image, such that the color parameter of the left-eye overlapped image matches that of the right-eye overlapped image. Finally, the adjusted left-eye image and right-eye image are output as a three dimensional image.

In an embodiment of the present invention, the step of analyzing the left-eye image and the right-eye image to find the left-eye overlapped image in the left-eye image and the right-eye overlapped image in the right-eye image includes: acquiring multiple features in the left-eye image and the right-eye image; and distinguishing the left-eye overlapped image in the left-eye image and the right-eye overlapped image in the right-eye image according to an area covered by the same features among the multiple features.

In an embodiment of the present invention, the step of analyzing the left-eye image and the right-eye image to find the left-eye overlapped image in the left-eye image and the right-eye overlapped image in the right-eye image includes: finding the left-eye overlapped image and the right-eye overlapped image according to a lens pitch between the left lens and the right lens, and a size of an image sensor of the left lens and a size of an image sensor of the right lens.

In an embodiment of the present invention, the step of adjusting the color parameters of the whole left-eye image and the whole right-eye image, such that the color parameter of the left-eye overlapped image matches that of the right-eye overlapped image includes: adjusting the color parameter of one of the left-eye image and the right-eye image by using the other one of the left-eye image and the right-eye image as a reference, such that the color parameter of the left-eye overlapped image matches that of the right-eye overlapped image.

In an embodiment of the present invention, the step of adjusting the color parameters of the whole left-eye image and the whole right-eye image, such that the color parameter of the left-eye overlapped image matches that of the right-eye overlapped image includes: calculating an average value and a standard deviation of the color parameters of the left-eye overlapped image and the right-eye overlapped image; and adjusting the color parameters of the whole left-eye image and the whole right-eye image to match the calculated average value and standard deviation.

In an embodiment of the present invention, the step of calculating the color parameters of the left-eye overlapped image and the right-eye overlapped image respectively includes: calculating brightness (Y) and chrominance components (Cb and Cr) of the left-eye overlapped image and the right-eye overlapped image respectively.

In an embodiment of the present invention, the step of adjusting the color parameters of the whole left-eye image and the whole right-eye image, such that the color parameter of the left-eye overlapped image matches that of the right-eye overlapped image includes: adjusting brightness of the whole left-eye image and the whole right-eye image, so that the brightness of the left-eye overlapped image matches that of the right-eye overlapped image; and adjusting chrominance of the whole left-eye image and the whole right-eye image, so that the chrominance of the left-eye overlapped image matches that of the right-eye overlapped image.

In an embodiment of the present invention, the step of calculating the color parameters of the left-eye overlapped image and the right-eye overlapped image respectively includes: calculating RGB chrominance components of the left-eye overlapped image and the right-eye overlapped image respectively.

In an embodiment of the present invention, the step of adjusting the color parameters of the whole left-eye image and the whole right-eye image, such that the color parameter of the left-eye overlapped image matches that of the right-eye overlapped image includes: adjusting RGB chrominance of the whole left-eye image and the whole right-eye image respectively, such that the RGB chrominance of the left-eye overlapped image matches that of the right-eye overlapped image.

The present invention provides a three dimensional imaging system, which includes a left lens, a right lens, and a processing unit. The left lens is used to capture a left-eye image, and the right lens is used to capture a right-eye image. A lens pitch exists between the left lens and the right lens. The processing unit is coupled to the left lens and the right lens, and is used to analyze the left-eye image and the right-eye image to find a left-eye overlapped image in the left-eye image and a right-eye overlapped image in the right-eye image, calculate a color parameter of the left-eye overlapped image and a color parameter of the right-eye overlapped image respectively to adjust the color parameters of the whole left-eye image and the whole right-eye image, such that the color parameter of the left-eye overlapped image matches that of the right-eye overlapped image, and output the adjusted left-eye image and right-eye image as a three dimensional image.

Based on the above, in the method for generating a three dimensional image and the three dimensional imaging system according to the present invention, color parameters of an overlapped area of a left-eye image and a right-eye image captured by the three dimensional imaging system are calculated and used to calibrate a deviation of brightness or chrominance of the whole left-eye image and the whole right-eye image, so as to obtain the left-eye image and the right-eye image with the matching brightness or chrominance.

In order to make the aforementioned features and advantages of the present invention more comprehensible, embodiments are described in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a three dimensional imaging system according to an embodiment of the present invention.

FIG. 2 is a flow chart of a method for generating a three dimensional image according to an embodiment of the present invention.

FIGS. 3(a) and 3(b) show an example of a method for generating a three dimensional image according to an embodiment of the present invention.

FIGS. 4(a) and 4(b) show an example of a method for generating a three dimensional image according to an embodiment of the present invention.

FIG. 5 is a flow chart of a method for generating a three dimensional image according to an embodiment of the present invention.

FIG. 6 is a flow chart of a method for generating a three dimensional image according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

A large area of a left-eye image and a large area of a right-eye image captured by a three dimensional imaging system overlap each other. Although certain disparity may occur to objects in the overlapped area which is captured by a left lens and a right lens at different angles, the substantial contents in the overlapped area are generally the same. Therefore, in order to eliminate the differences of brightness or chrominance between the left-eye image and the right-eye image, calibration is required to be performed on the images having the same contents in the overlapped area theoretically, to achieve an optimal effect. In addition, the adjustment of the images in the overlapped area is expanded to the whole left-eye image and the whole right-eye image, so as to obtain a three dimensional image with the matching brightness and chrominance.

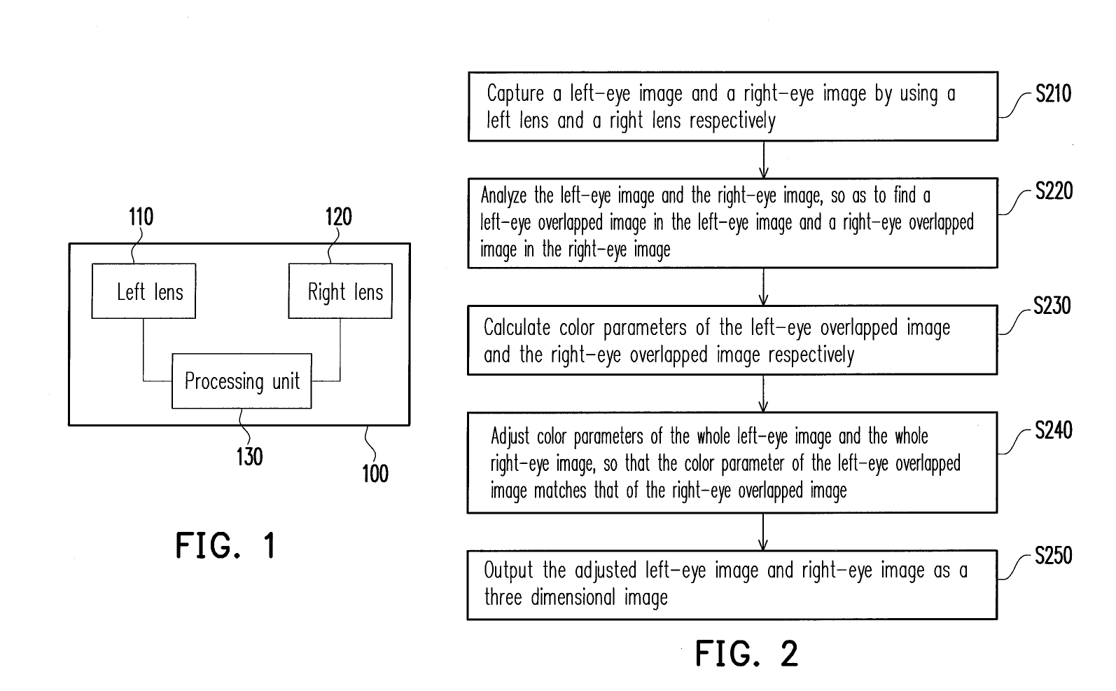

Specifically, FIG. 1 is a block diagram of a three dimensional imaging system according to an embodiment of the present invention. Referring to FIG. 1, the three dimensional imaging system 100 of this embodiment is, for example, a stereo camera, which includes a left lens 110, a right lens 120, and a processing unit 130.

The left lens 110 and the right lens 120 both have a photosensitive element (not shown), for sensing the intensity of light entering the left lens 110 and the right lens 120 respectively, and generating a left-eye image and a right-eye image. The photosensitive element is, for example, a Charge Coupled Device (CCD), a Complementary Metal-Oxide Semiconductor (CMOS), or other elements, and the present invention is not limited thereto. In addition, a lens pitch of about 77 mm exists between the left lens 110 and the right lens 120, to simulate an actual distance between human eyes.

The processing unit 130 is, for example, a Central Processing Unit (CPU), a programmable microprocessor, a Digital Signal Processor (DSP), a programmable controller, an Application Specific Integrated Circuit (ASIC), a Programmable Logic Device (PLD), or other devices, and is coupled to the left lens 110 and the right lens 120, for calibrating the left-eye image and the right-eye image captured by the left lens 110 and the right lens 120, so as to output a three dimensional image with the matching brightness and chrominance.

Specifically, FIG. 2 is a flow chart of a method for generating a three dimensional image according to an embodiment of the present invention. Referring to FIG. 1 and FIG. 2, the method of this embodiment is applicable to the three dimensional imaging system 100 in FIG. 1, and is used to calibrate differences of brightness and chrominance between a left-eye image and a right-eye image when a user uses the three dimensional imaging system 100 to capture a three dimensional image, so as to generate a three dimensional image with matching color. The process of the method of this embodiment is described in detail below with the elements of the three dimensional imaging system 100 in FIG. 1.

First, the left lens 110 and the right lens 120 are used to capture a left-eye image and a right-eye image respectively (Step S210). The left lens 110 and the right lens 120, for example, capture the images with the same parameters, including focal lengths, apertures, shutters, and white balances, and the present invention is not limited thereto.

Then, the processing unit 130 analyzes the left-eye image and the right-eye image, so as to find a left-eye overlapped image in the left-eye image and a right-eye overlapped image in the right-eye image (Step S220). The processing unit 130 may, for example, acquire multiple features in the left-eye image and the right-eye image, and distinguish the left-eye overlapped image in the left-eye image from the right-eye overlapped image in the right-eye image according to an area covered by the same features among the multiple features. Moreover, the processing unit 130 may also find the left-eye overlapped image and the right-eye overlapped image according to a lens pitch between the left lens and the right lens and a size of an image sensor of the left lens and a size of an image sensor of the right lens.

After finding the left-eye overlapped image and the right-eye overlapped image, the processing unit 130 calculates color parameters of the left-eye overlapped image and the right-eye overlapped image respectively (Step S230). The processing unit 130 may, for example, calculate brightness (Y) and chrominance components (Cb and Cr) of the left-eye overlapped image and the right-eye overlapped image respectively, or calculate RGB chrominance components of the left-eye overlapped image and the right-eye overlapped image respectively, to serve as a reference for subsequent calibration.

According to the above calculated color parameters, the processing unit 130 may further adjust color parameters of the whole left-eye image and the whole right-eye image, so that the color parameter of the left-eye overlapped image matches that of the right-eye overlapped image (Step S240). Finally, the adjusted left-eye image and right-eye image are output as a three dimensional image (Step S250). Specifically, since the left-eye overlapped image and the right-eye overlapped image have the same contents, and the environments in which the two images are captured are the same, the color parameters, such as the brightness and the chrominance, of the captured images should be the same. Thus, in this embodiment, the adjustment and calibration are performed on an overlapped area of the left-eye image and the right-eye image, and the scope of the adjustment is expanded to the whole left-eye image and the whole right-eye image, so that after the final adjustment, the brightness or color of the left-eye image matches that of the right-eye image no matter in the overlapped area or a non-overlapped area.

It should be noted that, in the above method for adjusting the left-eye image and the right-eye image, for example, one of the left-eye image and the right-eye image, or an average value of the two images is used as a reference for the adjustment, and the present invention is not limited thereto. Specifically, the processing unit 130 may use one of the left-eye image and the right-eye image as a reference to adjust the color parameter of the other, so that the color parameter of the left-eye overlapped image matches that of the right-eye overlapped image. Moreover, the processing unit 130 may also calculate an average value and a standard deviation of the color parameters of the left-eye overlapped image and the right-eye overlapped image, and adjust the color parameters of the whole left-eye image and the whole right-eye image accordingly, so that the adjusted color parameters match the calculated average value and standard deviation.

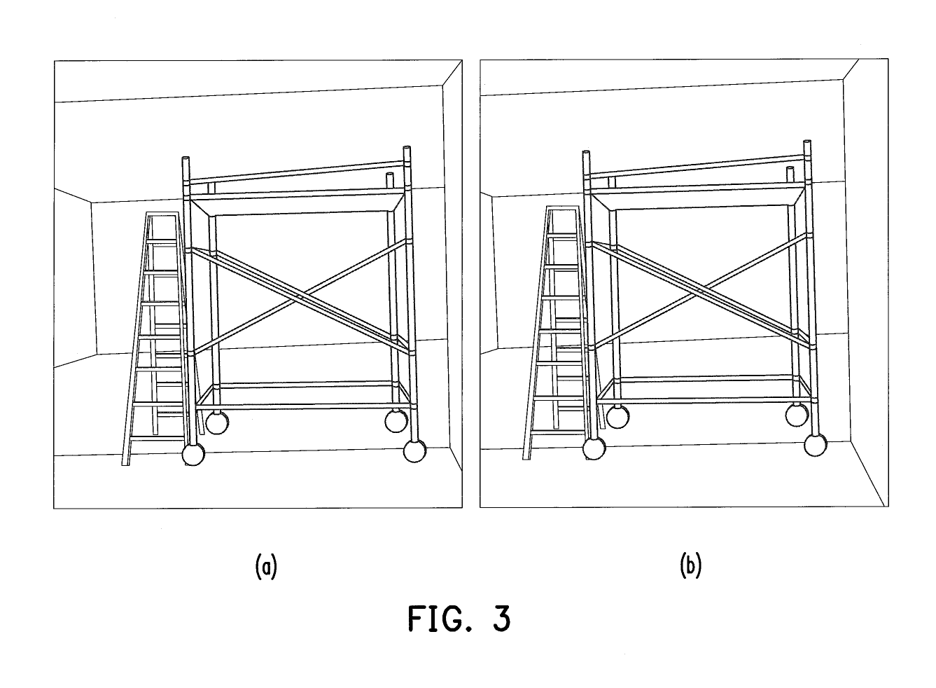

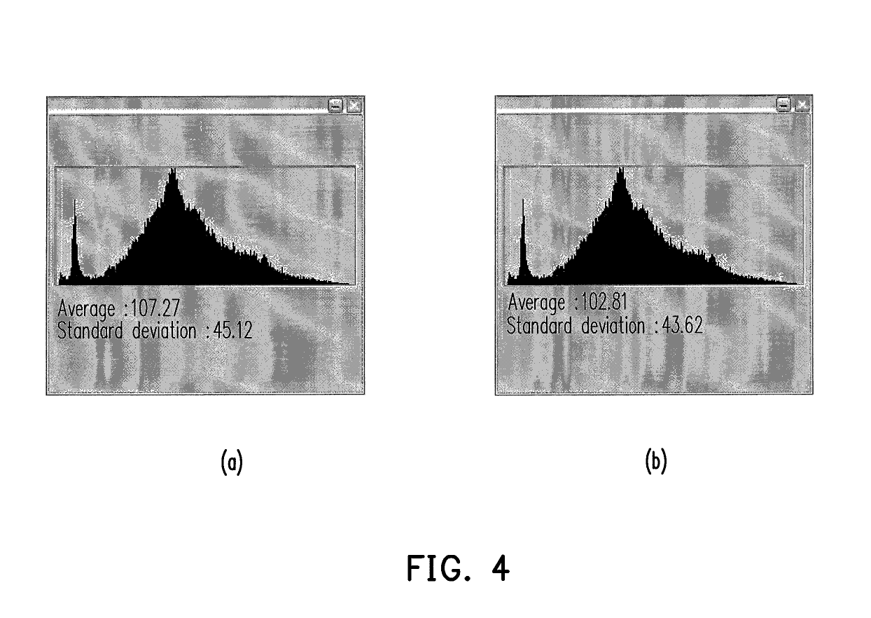

FIGS. 3 and 4 show examples of a method for generating a three dimensional image according to an embodiment of the present invention. In particular, FIGS. 3(a) and 3(b) represent a left-eye image and a right-eye image captured by the three dimensional imaging system respectively. FIGS. 4(a) and 4(b) are histograms of all pixels in an overlapped area of the left-eye image and all pixels in an overlapped area of the right-eye image. Referring to FIGS. 3(a) and 3(b), the brightness of the left-eye image is slightly different from that of the right-eye image, which may be caused by uncoordinated and separated processing of each of the images. It can be seen by analyzing the histograms of FIGS. 4(a) and 4(b) that the average value of the brightness of the left-eye image is higher, and thus it can be determined that the left-eye image is brighter. In this case, the difference of the brightness between the two images can be reconciled by simply increasing the brightness of the right-eye image, or decreasing the brightness of the left-eye image. Alternatively, both the brightness of the left-eye image and that of the right-eye image may be adjusted to an average value of the brightness of the two images to achieve the same effect.

Besides the difference of the brightness, if the difference of the chrominance is also taken into account, in the present invention, chrominance values of the left-eye image and the right-eye image in different color spaces may also be calculated respectively, and the color difference between the left-eye image and the right-eye image is reconciled accordingly by using the above adjustment mechanism, so as to obtain a desired three dimensional image. Another embodiment is given below for further description.

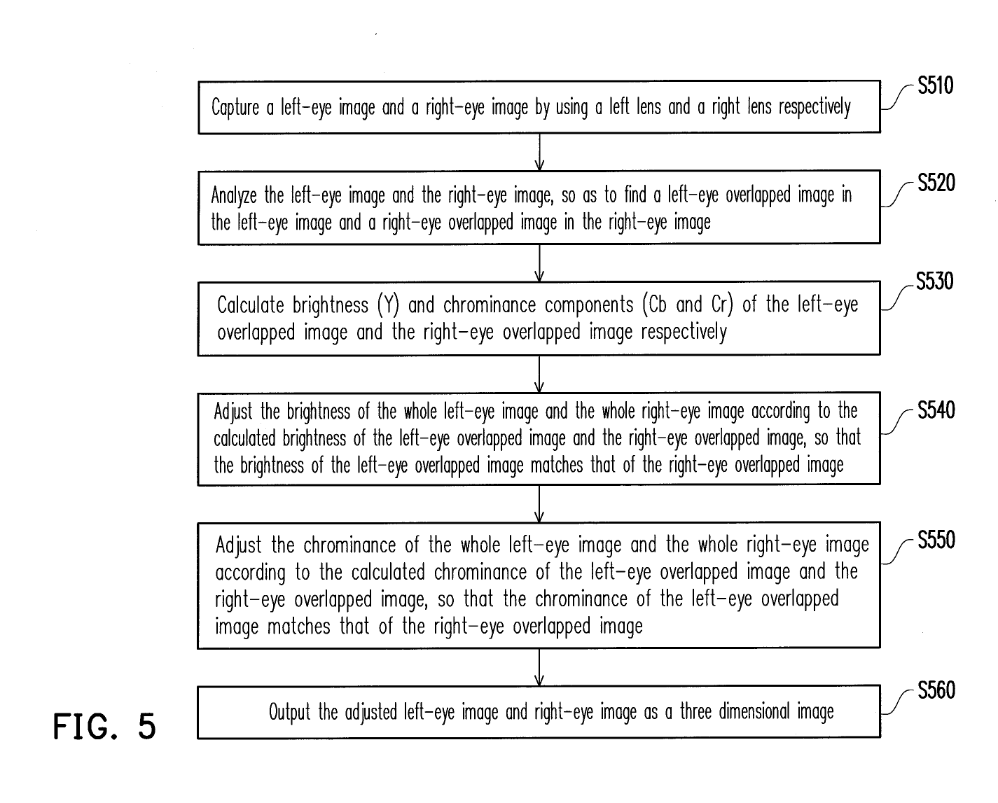

FIG. 5 is a flow chart of a method for generating a three dimensional image according to an embodiment of the present invention. Referring to FIG. 1 and FIG. 5, the method of this embodiment is applicable to the three dimensional imaging system 100 in FIG. 1, and is used to calibrate differences of brightness and chrominance between a left-eye image and a right-eye image by calculating brightness (Y) and chrominance components (Cb and Cr) of an overlapped area of the left-eye image and the right-eye image when a user uses the three dimensional imaging system 100 to capture a three dimensional image, so as to generate a three dimensional image with matching color. The process of the method of this embodiment is described in detail below with the elements of the three dimensional imaging system 100 in FIG. 1.

First, the left lens 110 and the right lens 120 are used to capture a left-eye image and a right-eye image respectively (Step S510). Then, the processing unit 130 analyzes the left-eye image and the right-eye image, so as to find a left-eye overlapped image in the left-eye image and a right-eye overlapped image in the right-eye image (Step S520). The details of Steps S510 to S520 are the same as or similar to those of Steps S210 to S220 in the above embodiment, and will not be described herein again.

The difference from the above embodiment is as follows. In this embodiment, the processing unit 130 calculates the brightness (Y) and chrominance components (Cb and Cr) of the left-eye overlapped image and the right-eye overlapped image respectively after the left-eye overlapped image and the right-eye overlapped image are found (Step S530). Next, the processing unit 130 adjusts the brightness of the whole left-eye image and the whole right-eye image according to the calculated brightness of the left-eye overlapped image and the right-eye overlapped image, so that the brightness of the left-eye overlapped image matches that of the right-eye overlapped image (Step S540). Then, the processing unit 130 adjusts the chrominance of the whole left-eye image and the whole right-eye image according to the calculated chrominance of the left-eye overlapped image and the right-eye overlapped image, so that the chrominance of the left-eye overlapped image matches that of the right-eye overlapped image (Step S550). Finally, the processing unit 130 outputs the adjusted left-eye image and right-eye image as a three dimensional image (Step S560).

Through the method in which the brightness and the chrominance are adjusted in different phases, the brightness and the chrominance of the left-eye image and the right-eye image are adjusted step by step, and finally the three dimensional image with the reconciled brightness and chrominance is obtained.

Moreover, in the present invention, chrominance values in other color spaces may also be adjusted directly step by step, and after all the chrominance values are adjusted, a three dimensional image of the reconciled brightness and chrominance may also be obtained. Another embodiment is given below for further description.

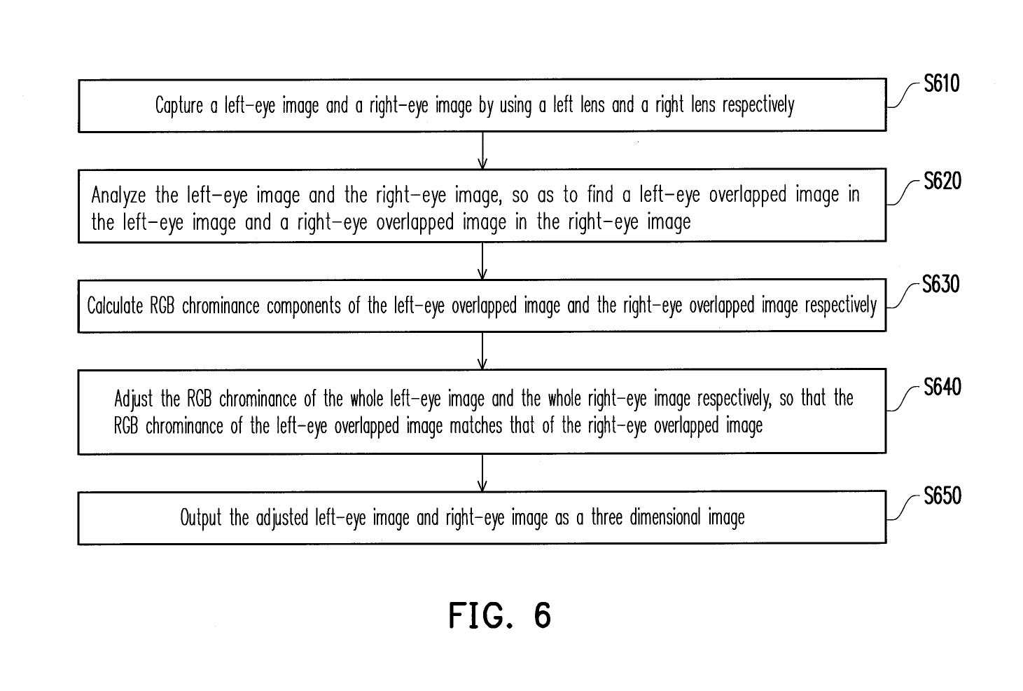

FIG. 6 is a flow chart of a method for generating a three dimensional image according to an embodiment of the present invention. Referring to FIG. 1 and FIG. 6, the method of this embodiment is applicable to the three dimensional imaging system 100 in FIG. 1, and is used to calibrate differences of brightness and chrominance between a left-eye image and a right-eye image by calculating RGB chrominance components of an overlapped area of the left-eye image and the right-eye image when a user uses the three dimensional imaging system 100 to capture a three dimensional image, so as to generate a three dimensional image with matching color. The process of the method of this embodiment is described in detail below with the elements of the three dimensional imaging system 100 in FIG. 1.

First, the left lens 110 and the right lens 120 are used to capture a left-eye image and a right-eye image respectively (Step S610). Then, the processing unit 130 analyzes the left-eye image and the right-eye image, so as to find a left-eye overlapped image in the left-eye image and a right-eye overlapped image in the right-eye image (Step S620). The details of Steps S610 to S620 are the same as or similar to those of Steps S210 to S220 in the above embodiment, and will not be described herein again.

The difference from the above embodiment is as follows. In this embodiment, the processing unit 130 calculates the RGB chrominance components of the left-eye overlapped image and the right-eye overlapped image respectively after the left-eye overlapped image and the right-eye overlapped image are found (Step S630). Then, the processing unit 130 adjusts the RGB chrominance of the whole left-eye image and the whole right-eye image according to the RGB chrominance components of the left-eye overlapped image and the right-eye overlapped image respectively, so that the RGB chrominance of the left-eye overlapped image matches that of the right-eye overlapped image (Step S640). Finally, the processing unit 130 outputs the adjusted left-eye image and right-eye image as a three dimensional image (Step S650).

For example, it is assumed that the following data are average values and standard deviations of the RGB chrominance calculated by the processing unit 130.

The left-eye image (R): the average value is 144.8, and the standard deviation is 53.

The left-eye image (G): the average value is 98, and the standard deviation is 45.

The left-eye image (B): the average value is 53, and the standard deviation is 37.

The right-eye image (R): the average value is 137, and the standard deviation is 50.

The right-eye image (G): the average value is 92.7, and the standard deviation is 43.

The right-eye image (B): the average value is 61.9, and the standard deviation is 43.

According to the above data, the color distribution of the left-eye image does not match that of the right-eye image at the two sides. Assuming that the processing unit 130 adjusts by using an average value of the two images as a reference, if a newly calculated reference image has an average value of X_u and a standard deviation of X_std; and the left-eye image and the right-eye image to be adjusted have an average value of M_u and a standard deviation of M_std, a pixel having an original value of M in the left-eye image and the right-eye image has a pixel value Y after the adjustment satisfying the following relationship with the aforementioned parameters:

Y=(M−M_{—}u)×X_{—}std/M_{—}std+X_{—}u

The processing unit 130 calculates the chrominance values after the adjustment by using the above formula, and adjusts the RGB chrominance respectively, so that the overall brightness and chrominance of the left-eye image matches those of the right-eye image, thus improving the quality of the three dimensional image. In addition to the above chrominance conversion method, in the present invention, an image histogram matching method may also be used to adjust the color parameters of the whole left-eye image and the whole right-eye image, to achieve a similar effect.

In view of the above, in the method for generating a three dimensional image and the three dimensional imaging system in the present invention, the color distribution of images in an overlapped area of a left-eye image and a right-eye image in different color spaces is analyzed to adjust the brightness or chrominance of the whole left-eye image and the whole right-eye image, so that the brightness and color of one image matches those of the other, thus effectively improving the quality of the three dimensional image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating a three dimensional image, applicable to a three dimensional imaging system comprising a left lens and a right lens, the method comprising:
capturing a left-eye image and a right-eye image by using the left lens and the right lens respectively;
analysing the left-eye image and the right-eye image, so as to find a left-eye overlapped image in the left-eye image and a right-eye overlapped image in the right-eye image;
calculating a color parameter of the left-eye overlapped image and a color parameter of the right-eye overlapped image respectively;
adjusting the color parameters of the whole left-eye image and the whole right-eye image, so that the color parameter of the left-eye overlapped image matches that of the right-eye overlapped image; and
outputting the adjusted left-eye image and right-eye image as a three dimensional image.

2. The method for generating the three dimensional image according to claim 1, wherein the step of analyzing the left-eye image and the right-eye image, so as to find the left-eye overlapped image in the left-eye image and the right-eye overlapped image in the right-eye image comprises:
acquiring multiple features in the left-eye image and the right-eye image; and
distinguishing the left-eye overlapped image in the left-eye image and the right-eye overlapped image in the right-eye image according to an area covered by the same features among the multiple features.

3. The method for generating the three dimensional image according to claim 1, wherein the step of analyzing the left-eye image and the right-eye image, so as to find the left-eye overlapped image in the left-eye image and the right-eye overlapped image in the right-eye image comprises:
finding the left-eye overlapped image and the right-eye overlapped image according to a lens pitch between the left lens and the right lens, and a size of an image sensor of the left lens and a size of an image sensor of the right lens.

4. The method for generating the three dimensional image according to claim 1, wherein the step of adjusting the color parameters of the whole left-eye image and the whole right-eye image, such that the color parameter of the left-eye overlapped image matches that of the right-eye overlapped image comprises:
adjusting the color parameter of one of the left-eye image and the right-eye image by using the other one of the left-eye image and the right-eye image as a reference, such that the color parameter of the left-eye overlapped image matches that of the right-eye overlapped image.

5. The method for generating the three dimensional image according to claim 1, wherein the step of adjusting the color parameters of the whole left-eye image and the whole right-eye image, such that the color parameter of the left-eye overlapped image matches that of the right-eye overlapped image comprises:
calculating an average value and a standard deviation of the color parameters of the left-eye overlapped image and the right-eye overlapped image; and
adjusting the color parameters of the whole left-eye image and the whole right-eye image to match the calculated average value and standard deviation.

6. The method for generating the three dimensional image according to claim 1, wherein the step of calculating the color parameters of the left-eye overlapped image and the right-eye overlapped image respectively comprises:
calculating brightness (Y) and chrominance components (Cb and Cr) of the left-eye overlapped image and the right-eye overlapped image respectively.

7. The method for generating the three dimensional image according to claim 6, wherein the step of adjusting the color parameters of the whole left-eye image and the whole right-eye image, such that the color parameter of the left-eye overlapped image matches that of the right-eye overlapped image comprises:
adjusting brightness of the whole left-eye image and the whole right-eye image, so that the brightness of the left-eye overlapped image matches that of the right-eye overlapped image; and
adjusting chrominance of the whole left-eye image and the whole right-eye image, so that the chrominance of the left-eye overlapped image matches that of the right-eye overlapped image.

8. The method for generating the three dimensional image according to claim 1, wherein the step of calculating the color parameters of the left-eye overlapped image and the right-eye overlapped image respectively comprises:
calculating RGB chrominance components of the left-eye overlapped image and the right-eye overlapped image respectively.

9. The method for generating the three dimensional image according to claim 8, wherein the step of adjusting the color parameters of the whole left-eye image and the whole right-eye image, such that the color parameter of the left-eye overlapped image matches that of the right-eye overlapped image comprises:
adjusting RGB chrominance of the whole left-eye image and the whole right-eye image, so that the RGB chrominance of the left-eye overlapped image matches that of the right-eye overlapped image.

10. A three dimensional imaging system, comprising:
a left lens, for capturing a left-eye image;
a right lens, for capturing a right-eye image, with a lens pitch existing between the left lens and the right lens; and
a processing unit, coupled to the left lens and the right lens, for analyzing the left-eye image and the right-eye image, to find a left-eye overlapped image in the left-eye image and a right-eye overlapped image in the right-eye image, calculating a color parameter of the left-eye overlapped image and a color parameter of the right-eye overlapped image respectively to adjust the color parameters of the whole left-eye image and the whole right-eye image, such that the color parameter of the left-eye overlapped image matches that of the right-eye overlapped image, and outputting the adjusted left-eye image and right-eye image as a three dimensional image.
